(19) United States
(12) Patent Application Publication
(10) Pub. No.: US 2014/0131479 A1
(43) Pub. Date: May 15, 2014

(54) AIRCRAFT TURBOJET ENGINE THRUST REVERSER WITH A LOWER NUMBER OF ACTUATORS

(71) Applicant: AIRCELLE, (US)

(72) Inventors: Olivier Kerbler, Antony (FR); Nicolas Dezeustre, La Havre (FR); Herve Hurlin, Igny (FR)

(73) Assignee: AIRCELLE, GONFREVILLE L'ORCHER (FR)

(21) Appl. No.: 13/875,856

(22) Filed: May 2, 2013

Related U.S. Application Data
(63) Continuation of application No. PCT/FR2011/052544, filed on Oct. 28, 2011.

(30) Foreign Application Priority Data
Nov. 3, 2010 (FR) 10/59031

(51) Int. Cl. F02K 1/56

(52) U.S. Cl. CPC F02K 1/566
USPC 239/265.19

(57) ABSTRACT

This cascade-type thrust reverser with one-piece moving cowl includes rails able to slide in guideways positioned on each side of a suspension pylon. This thrust reverser includes just two actuators positioned near the rails and able to cause this cowl to slide on the guideways between its direct-jet and reverse-jet positions. It also has means capable of compensating for forces that have a tendency to misalign the rails with respect to the guideways, thus preventing them from jamming in one another.

### CROSS-REFERENCE TO RELATED APPLICATIONS

This application is a continuation of International Application No. PCT/FR2011/052544 filed on Oct. 28, 2011, which claims the benefit of FR 10/59031, filed on Nov. 3, 2010. The disclosures of the above applications are incorporated herein by reference.

### FIELD

The present disclosure relates to a thrust reverser for an aircraft turbojet engine.

### BACKGROUND

The statements in this section merely provide background information related to the present disclosure and may not constitute prior art.

An airplane is moved by several turbojet engines each housed in a nacelle serving to channel the flows of air created by the turbojet engine that also houses a set of actuating devices performing various functions when the turbojet engine is operating or stopped.

These actuating devices may in particular comprise a mechanical thrust reversal system.

A nacelle generally has a tubular structure comprising an air inlet upstream from the turbojet engine, a middle section designed to surround a fan of the turbojet engine, a downstream section housing thrust reverser means and designed to surround the combustion chamber of the turbojet engine, and generally ends with a jet nozzle whereof the outlet is situated downstream from the turbojet engine.

Modern nacelles are designed to house a dual-flow turbojet engine capable of using the blades of the fan to create a flow of air whereof a portion, called the hot or primary flow, circulates in the combustion chamber of the turbojet engine, and whereof the other portion, called the cold or secondary flow, circulates outside the turbojet engine through an annular passage, also called tunnel, formed between a fairing of the turbojet engine and an inner wall of the nacelle. The two flows of air are discharged from the turbojet engine through the rear of the nacelle.

The role of a thrust reverser is, during landing of an aircraft, to improve the braking capacity thereof by reorienting at least part of the thrust created by the turbojet engine forward. In this phase, the reverser obstructs the cold flow tunnel and orients that flow toward the front of the nacelle, thereby creating a counter-thrust that is added to the braking of the wheels of the aircraft.

The means used to perform this reorientation of the cold flow vary depending on the type of reverser. However, in all cases, the structure of a reverser comprises movable cowls (or doors) that can be moved between a closed or “direct jet” position, in which they close that passage, and an open or “reverse jet” position, in which they open a passage intended for the deviated flow in the nacelle. These cowls can perform a deviating function or simply serve to activate other deviating means.

In the case of a cascade-type thrust reverser, also called a cascade reverser, the reorientation of the air flow is oriented through the cascade vanes, the cowl having a simple sliding function aiming to expose or cover those vanes.

The moving cowl is translated along a longitudinal axis substantially parallel to the axis of the nacelle. Thrust reverser flaps, actuated by the sliding of the cowl, make it possible to obstruct the cold flow tunnel downstream from the cascade vanes, so as to optimize the reorientation of the cold flow toward the outside of the nacelle.

Known from the prior art, and in particular document FR 2 916 426, is a cascade-type thrust reverser whereof the moving cowl is one piece and slidingly mounted on guideways arranged on either side of the suspension pylon of the assembly formed by the turbojet engine and its nacelle.

“One-piece cowl” refers to a quasi-annular cowl, extending from one side of the pylon to the other without interruption.

Such a cowl is often designated by the term “O-duct,” referring to the shroud shape of such a cowl, as opposed to the “D-duct,” which in fact comprises two half-cowls each extending over a half-circumference of the nacelle.

The sliding of an “O-duct”-type cowl between its “direct jet” and “reverse jet” position is traditionally ensured by a plurality of actuators, of the electromechanical type (for example: worm screw actuated by an electric motor and moving a nut) or hydraulic motor type (cylinders actuated by pressurized oil).

Typically, there are four or six actuators, i.e., two or three actuators respectively distributed on each half of the thrust reverser, on either side of the suspension pylon.

### SUMMARY

The present disclosure simplifies these actuating means, both to reduce costs and to reduce the mass of the nacelle.

The present disclosure provides a cascade-type thrust reverser with a one-piece moving cowl comprising rails able to slide in guideways positioned on either side of a suspension pylon, this thrust reverser comprising only two actuators positioned near said rails and able to cause this cowl to slide on said guideways between its direct jet and reverse jet positions, and comprising means capable of compensating for forces that have a tendency to misalign said rails with respect to said guideways, thus preventing them from jamming in one another, remarkable in that said means are selected from the group comprising:
means for compensating the tilting torque of the moving cowl caused by the pressurization of the cold flow tunnel of the reverser, and
thrust reverser flaps of the reverser, arranged so as to exert a thrust force on the upstream edge of the inner wall of said moving cowl.

The presence of only two actuators is a considerable simplification with respect to the thrust reversers of the prior art, this simplification making it possible to achieve substantial cost and mass reductions.

However, this simplification causes risks of jamming of the sliding of the moving cowl, that jamming being able to be avoided owing to the aforementioned compensating means.

In fact, due to the substantially conical shape of the inner wall of the moving cowl, the resultant of the pressure forces from this cold air in fact tends to form a tilting torque of the moving cowl with the resultant of the forces exerted by the actuators; by compensating for that torque, the risks of jamming are therefore reduced.

Regarding thrust reverser flaps, the thrust force, present both upon opening and closing of the moving cowl, makes it possible to apply a force distributed substantially homogenously over the entire periphery of the moving cowl, which makes it possible to reduce the intensity of the aforementioned tilting torques.

Other optional features of the thrust reverser according to the present disclosure:

said compensating means comprise means for pressurizing the outer wall of said outer cowl: by pressurizing the outer wall of the moving cowl, the shape of which is also conical, but inverted relative to that of the inner wall of the cowl, the effect of the aforementioned tilting torque is substantially reduced;

said pressurizing means comprise an O-ring arranged upstream from the outer wall of said moving cowl, and an absence of seal upstream from the inner wall of said moving cowl: by eliminating the seal of the inner wall and attaching it on the outer wall, the cold air that is pressurized in the cold flow tunnel is allowed to fill the space between the inner and outer walls of the moving cowl, and thus to pressurize at least part of the outer wall;

said pressurizing means comprise an O-ring on the inner wall of said moving cowl, associated with a limited leak on the outer wall and at least one expander situated through the inner wall: the role of these expanders is to ensure pressure in the space situated between the inner and outer walls of the moving cowl that cancels the resultant of the axial forces of the moving cowl; optionally, this expander can be piloted.

Further areas of applicability will become apparent from the description provided herein. It should be understood that the description and specific examples are intended for purposes of illustration only and are not intended to limit the scope of the present disclosure.

### DRAWINGS

In order that the present disclosure may be well understood, there will now be described various forms thereof, given by way of example, reference being made to the accompanying drawings, in which:

FIG. 1 is a global diagrammatic illustration of a turbojet engine nacelle having a thrust reverser according to the disclosure, i.e., including a one-piece moving cowl (O-duct type reverser), the inside of which is shown in transparence;

FIG. 2 is a longitudinal cross-sectional diagrammatic illustration of the nacelle of FIG. 1;

FIGS. 3 to 5 are longitudinal half-sectional views of the thrust reverser of the nacelle of FIGS. 1 and 2, in three successive positions;

FIG. 6 shows, diagrammatically and in transverse cross-section, the positioning of the two actuators of the moving cowl of the thrust reverser of FIGS. 3 to 5;

FIG. 7 shows, diagrammatically and in longitudinal cross-section, the tilting torque to which the moving cowl is subjected;

FIG. 8 shows, diagrammatically and in longitudinal cross-section, a suitable position of an O-ring on the moving cowl of the thrust reverser according to the present disclosure; and

FIG. 9 shows a diagrammatic detailed view of the mechanism in area XII of FIG. 5.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In all of these figures, identical or similar references designate identical or similar members or sets of members.

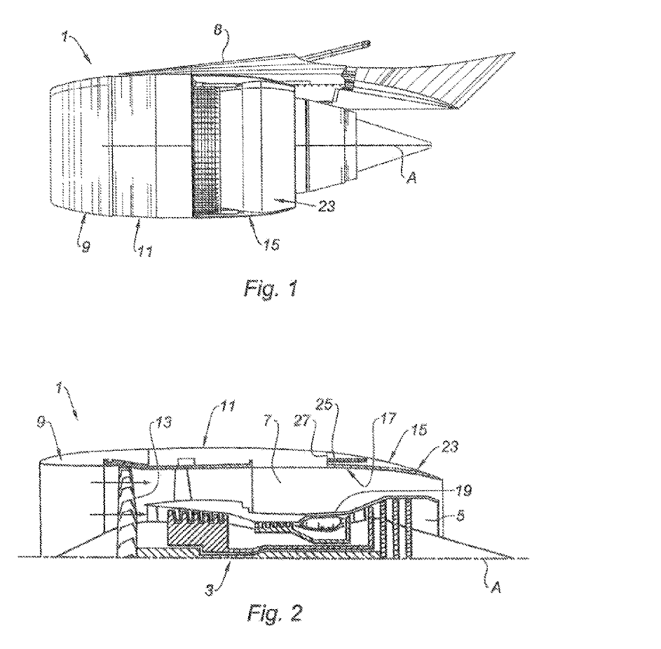

In reference to FIGS. 1 and 2, a nacelle 1 is designed to form a tubular housing for a dual-flow turbojet engine 3 and serves to channel the hot 5 and cold 7 air flows created by that turbojet engine 3, as indicated in the preamble of the present description.

This nacelle 1 is designed to be suspended from a pylon 8, which in turn is fixed under the wing of an aircraft.

As previously indicated, the nacelle 1 generally has a structure comprising an upstream section 9 formed by an air intake, a middle section 11 surrounding the fan 13 of the turbojet engine 3, and a downstream section 15 surrounding the turbojet engine 3.

The downstream section 15 comprises an outer structure 17 having a thrust reverser device and an inner fairing structure 19 of the engine 3 of the turbojet engine defining, with the outer structure 17, the cold flow tunnel 7, in the case of a dual-flow turbojet engine nacelle as presented here.

The thrust reverser device comprises a cowl 23 translatably mounted in a direction substantially parallel to the longitudinal axis A of the nacelle 1.

This cowl 23 is able to alternate between a closed position (position shown in FIGS. 1 and 2), in which it ensures the aerodynamic continuity of the lines of the downstream section 15 of the nacelle 1 and covers the air flow cascade vanes 25, to an open position in which it opens the passage in the nacelle 1 by exposing those cascade vanes 25.

More specifically, in the context of the present disclosure, the moving cowl 23 is one-piece, i.e., it comprises a single one-piece moving cowl, with a quasi-annular shape, extending from one side of the pylon 8 to the other without interruption (O-duct moving cowl).

The cascade vanes 25 each have a plurality of deflecting blades.

As illustrated in FIG. 2, the downstream section 15 may also comprise a front frame 27 that extends upstream from the cowl 23 and attaches the downstream section 15 with the middle section 11 surrounding the fan 13 of the turbojet engine.

The translation of the moving cowl 23 in the downstream direction of the nacelle frees an opening therein through which the cold flow from the turbojet engine can escape at least partially, that flow portion being reoriented toward the front of the nacelle by the cascade vanes 25, thereby creating a counter-thrust capable of contributing to the braking of the airplane.

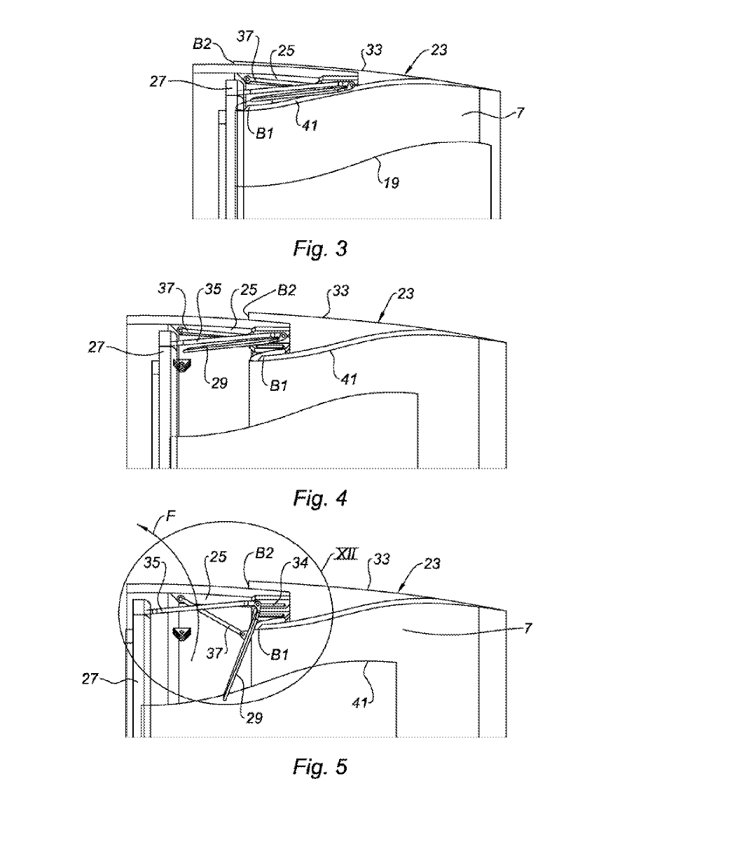

The orientation of the cold flow toward the cascade vanes 25 is done by a plurality of reverser flaps 29 (FIGS. 3 to 5 and 9), distributed on the inner circumference of the moving cowl 23, each pivotably mounted between a retracted position (see FIGS. 3 and 4), in which those flaps 29 ensure the inner aerodynamic continuity of the cold flow tunnel 7, and a deployed position in which, in the reverse thrust situation, they at least partially obstruct that tunnel and deviate the cold flow through the cascade vanes 25.

Reference will now be made more particularly to FIGS. 3 to 5, which show a thrust reverser according to the disclosure in three successive positions.

In FIG. 3, the thrust reverser is shown in the “direct jet” position, i.e., in the position where the cold flow 7 circulates directly from upstream to downstream of the nacelle: this position corresponds to the cruising flight situation of the aircraft.

FIG. 4 shows the moving cowl 23 in the process of going to the “reverse jet” position of FIG. 5.

In this position, the cold flow is deviated by the thrust reverser flaps 29 through the cascade vanes 25, as indicated by the arrow F, making it possible to perform braking of the aircraft.

More specifically, in the form shown in FIGS. 3 to 5, the thrust reverser vanes 25 are of the retractable type, i.e., they are capable of sliding from upstream position (FIGS. 3 and 4) to a downstream position (FIG. 5), under the effect of the opening of the moving cowl 23.

As shown in FIG. 9, the downstream sliding movement of the thrust reverser vanes 25 is done by stops 31 arranged appropriately on the upstream edge of the outer wall 33 of the moving cowl 23.

More specifically, the thrust reverser flaps 29 are each pivotably and slidingly mounted inside grooves 34 secured to the thrust reverser vanes 25.

A first connecting rod 35 connects the pivoting and sliding end of each flap 29 to the fixed front frame 27, or any other fixed structure, and the second connecting rod 37 is articulated on the one hand substantially midway through the length of the thrust reverser flaps 29, and on the other hand in the upstream area of the thrust reverser vanes 25.

When the moving cowl 23 goes from the position of FIG. 3 to that of FIG. 4, the two connecting rods 35, 37 and the associated thrust reverser flap 29 remaining immobile, allowing that thrust reverser flap to leave the cavity defined by the outer 33 and inner 41 walls of the moving cowl 23.

When the moving cowl 23 continues to slide to reach the position shown in FIG. 5, the stops 31 arranged on the upstream edge of the outer wall 33 of the moving cowl result in causing the thrust reverser vanes 25 to slide toward a downstream position visible in FIG. 5.

Under the effect of this sliding, the first connecting rod 35 results in sliding the articulation point of the end of the thrust reverser flaps 29 to the inside of the groove 34, allowing that thrust reverser flap to be removed from the cavity defined by the walls 33 and 41.

The second connecting rod 37 results in pivoting the thrust reverser flap 29 until it reaches its position obstructing the cold flow tunnel 7, shown in FIG. 5, making it possible to orient that cold flow through the thrust reverser vanes 25, in the upstream direction of the nacelle 1.

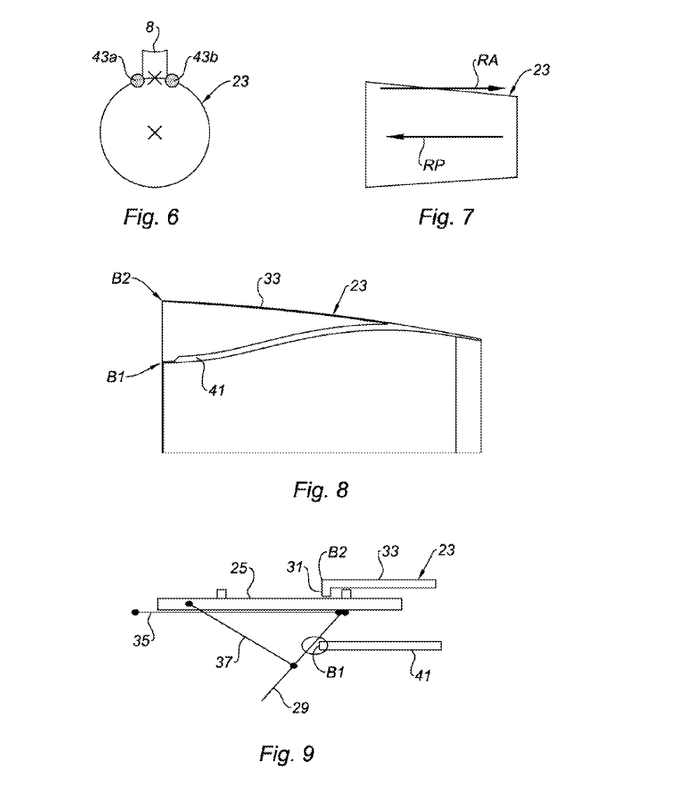

The means for actuating the moving cowl 23, making it possible to slide from one to the other of the positions shown in FIGS. 3 to 5, are shown diagrammatically in FIG. 6. These means comprise two unique actuators 43a and 43b arranged in the upper part of the moving cowl (i.e., toward the top of sheet 3/4 of the drawings appended hereto), on either side of the suspension pylon 8.

These actuators can be hydraulic cylinders, or actuators of the electromechanical type, such as worm screw and nut systems.

Due to the substantially tapered shape of the inner wall 41 of the moving cowl 23, that shape flaring in the downstream direction of the nacelle, the resultant RP of the pressure forces from the cold air on that inner wall is oriented toward the upstream direction of the nacelle, as shown in FIG. 7, when the moving cowl is in the direct jet position.

This resultant RP therefore results in creating a tilting torque with the resultant RA of the forces exerted by the actuators 43a and 43b, during opening of the moving cowl 23.

This tilting torque risks resulting in blocking the rails (not shown) arranged in the upper part of the moving cowl 23, allowing that moving cowl to slide in two guideways (not shown) arranged on either side of the suspension pylon 8.

To avoid this, it is proposed to offset the O-ring, which is typically found on the upstream edge B1 of the inner wall 41 of the moving cowl 23, toward the edge B2 of the outer wall 33 of that moving cowl.

In so doing, the pressurized cold air 7 in the cold air tunnel of the nacelle fills the cavity defined by the outer 33 and inner 41 walls of the moving cowl 23.

In this way, and due to the tapered shape of the outer wall 33, narrowing in the downstream direction of the nacelle, the resultant of the pressure forces exerted by the cold air is oriented in the same direction as the resultant RA exerted by the actuators 43a and 43b at the opening of the moving cowl 23. In this way, the tilting torque is eliminated that is created by the pressure of the air inside the cold flow tunnel, and the risks of jamming created by that pressure are thereby illuminated.

In another form, it is possible to consider an O-ring arranged upstream from the inner wall 41, associated with a limited leak on the outer wall and at least one expander passing through the inner wall 41. The role of this expander is to ensure pressure in the space situated between the inner 41 and outer 43 walls of the moving cowl, which cancels the resultant of the axial forces of the moving cowl; optionally, this expander may be piloted.

Another source of risks of jamming of the rails of the moving cowl 23 in their associated guideways is the upwardly offset position of the actuators 43a and 43b, i.e., their considerably asymmetrical positioning relative to a horizontal plane cutting through the nacelle: such an asymmetrical positioning in fact intrinsically creates buttressing forces between the rails of the moving cowl 23 and the associated guideways, said buttressing being able to create friction that can result in blocking situations.

One form for reducing this risk of blocking caused by such buttressing consists of placing each actuator 43 in the extension of the associated rail 45 of the moving cowl 23.

With this particular arrangement, the thrust and traction forces exerted by the actuators 43a and 43b are exerted directly in the sliding axis of each rail with its associated guideway, thereby eliminating any tilting movements and the associated risks of buttressing and jamming.

Another form to reduce these risks of buttressing and jamming may consist of fixing the cable 55 to the end of the rail 45 of the moving cowl 23, as shown in FIGS. 10 and 11.

Another manner, complementary to those previously described, for reducing the tilting torque of the moving cowl 23 inherent to the asymmetrical positioning of the actuators 43a, 43b relative to the horizontal plane of the nacelle consists of using the thrust reverser flaps 29 themselves.

More specifically, as shown in particular in FIG. 5, the geometry of the movement of the thrust reverser flaps 29 can be chosen such that they abut against the upstream edge B1 of the inner wall 41 of the moving cowl 23.

In this way, these thrust reverser flaps 29, under the effect of the thrust exerted by the cold flow 7, press on the entire circumference of the edge B1 of the inner wall 41, thereby exerting a thrust force distributed circumferentially on that inner wall, and therefore on the moving cowl 23 assembly.

This circumferential distribution of the force makes it possible to counter the tilting torque created by the asymmetrical positioning of the actuators 43a and 43b, and thereby actively contributes to reducing the risks of subsequent buttressing and jamming.

As can be seen in light of the preceding, the present disclosure provides a thrust reverser with a particularly simplified and lightened design, owing to the use of only two actuators, arranged on either side of the suspension pylon of the nacelle.

This limitation of the number of actuators, as well as their particular position, poses difficulties resulting from the tilting torques created on the one hand by the pressurization of the cold air in the nacelle, and on the other hand by the asymmetrical forces created by those actuators, during opening and closing of the moving cowl.

To resolve these difficulties, and allow such a use of only two actuators, the aforementioned means can be used, alone or in combination, making it possible to compensate for the tilting forces of the moving cowl of the thrust reverser.

It will be noted that the use of a thrust reverser with retractable vanes (see FIGS. 3 to 5) is completely optional in the context of the present disclosure.

Of course, the present disclosure is in no way limited to the forms described and shown, which are provided purely as an illustration.

What is claimed is:

1. A cascade-type thrust reverser with a one-piece moving cowl comprising rails able to slide in guideways positioned on either side of a suspension pylon, comprising only two actuators positioned near said rails and able to cause this cowl to slide on said guideways between its direct jet and reverse jet positions, and comprising means capable of compensating for forces that have a tendency to misalign said rails with respect to said guideways, thus preventing them from jamming in one another, wherein said means are selected from at least one of:
means for compensating the tilting torque of the moving cowl caused by the pressurization of the cold flow tunnel of the reverser, and
thrust reverser flaps of the reverser, arranged so as to exert a thrust force on the upstream edge of the inner wall of said moving cowl.

2. The reverser according to claim 1, wherein said compensating means comprise means for pressurizing the outer wall of said outer cowl.

3. The reverser according to claim 2, wherein said pressurizing means comprise an O-ring arranged upstream from the outer wall of said moving cowl, and an absence of seal upstream from the inner wall of said moving cowl.

4. The thrust reverser according to claim 2, wherein said pressurizing means comprise an O-ring on the inner wall of said moving cowl, associated with a limited leak on the outer wall and at least one expander situated through the inner wall.

5. A nacelle for a turbojet engine of an aircraft, wherein it comprises a thrust reverser according to claim 1.
